(19) United States
(12) Patent Application Publication
(10) Pub. No.: US 2007/0063369 A1
(43) Pub. Date: Mar. 22, 2007

(54) Method of molding a tire

(75) Inventor: Francis J. Byrne, Medina, OH (US)

Correspondence Address: Chief IP Counsel;Bridgestone Americas Holding, Inc., 1200 Firestone Parkway, Akron, OH, 44317, US

(73) Assignee: Bridgestone Firestone North American Tire, LLC

(21) Appl. No.: 11/229,906

(22) Filed: Sep. 19, 2005

(51) Int. Cl. B29D 30/00

(52) U.S. Cl. 264/85; 264/326; 264/129; 264/315; 425/28.1; 425/35

(57) ABSTRACT

A method of molding a tire is provided. The method includes the steps of placing a green tire in a mold wherein the mold has internal cavity-defining surfaces, injecting an injection gas into a space defined between an external surface of the green tire and the internal cavity-defining surfaces of the mold and curing the green tire within the mold.

### FIELD OF THE INVENTION

This invention relates generally to a method of molding a tire and, more particularly, to a method of molding a tire that eliminates the need for one or more post-molding processing steps.

### BACKGROUND OF THE INVENTION

One process for converting uncured rubber into a product that will resist heat and cold, in addition to having considerable mechanical strength, is called vulcanizing or curing. The rubber used in manufacturing a pneumatic tire is generally prepared for the vulcanization process by adding sulfur and/or other vulcanizing agents, such as accelerators, to the rubber. Thereafter, the tire is constructed from various components, including a carcass body comprised of plies of reinforcement cords buried in rubber. Before vulcanization, the tire is known in the art as a green tire.

A process to cure the rubber in a tire includes (1) placing a green tire over a bladder in a tire mold, and then (2) pressurizing the bladder with a high temperature fluid (e.g., steam or hot water) and/or gas (e.g., air or nitrogen) to support the tire during curing. The mold is then collapsed around the green tire, thereby forcing the mold into the green tire and subjecting the green tire to heat and pressure of a high temperature fluid and/or gas for a predetermined time. The pressurized high temperature fluid and/or gas is provided in the bladder until cure is completed—wherein the heat transferred to the tire from high temperature fluids and/or gases in the bladder is generally called internal curing.

The high temperature fluid and/or gas used to support the green tire can be supplied from sources located internal and/or external to the tire. In addition, heat may be supplied external to the mold before, after or while the mold is being closed around the partially inflated green tire. Such external heat, if used, is transmitted through the mold to the tire to assist in the curing of the green tire.

A tire mold typically includes a container and mold segments, which are replaceably mounted within the container. Internal surfaces of the mold segment define a mold cavity having the desired contour of the finished tire. A green tire is placed in the mold cavity and, initially, a space exists between the circumference of the green tire and the internal cavity-defining surfaces of the mold. When the mold is collapsed around the green tire, the internal mold surfaces press against the green tire.

The initial space between the green tire and the internal mold surfaces results in air being trapped between the rubber material and the mold surfaces after the mold is collapsed around the green tire. More particularly, a pattern exists in the internal surface of the mold, the pattern being formed in the mold by projections and/or recesses formed in and/or on the internal surface of the mold. The mold pattern and the unvulcanized rubber act to close off the escape paths that allow the air to escape. As a result, air pockets are trapped in unvented portions of the mold during the curing process. The air pockets, in turn, can result in the formation of recesses or lightness in and/or on the surface of the molded tire, thereby deteriorating the finished appearance of the tire and the loss of design intent.

### SUMMARY

A method of molding a tire includes the steps of placing a green tire in a mold wherein the mold has internal cavity-defining surfaces, injecting an injection gas into a space defined between an external surface of the green tire and the internal cavity-defining surfaces of the mold and curing the green tire within the mold.

A system for molding a tire includes a mold assembly having an internal cavity and an external surface. The mold assembly is capable of being opened and is formed from an upper portion and a lower portion, the upper and lower portions combining to form the internal cavity. The mold assembly further includes at least one tread imparting structure for forming a tread pattern on an exterior surface of the tire, at least one inlet port located in the mold assembly, wherein the at least one inlet port is adapted to supply an injection gas to the internal cavity of the mold assembly, and at least one exit port located in the mold assembly, wherein the at least one exit port is adapted to vent any ambient air trapped in the internal cavity during a tire molding process. The system further includes means for supplying the injection gas to the mold assembly via the at least one inlet port.

A tire mold includes a mold housing having an internal surface that defines an internal cavity and an external surface. The mold housing includes at least two passages that extend from the internal surface to the external surface. The at least two passages are configured to vent ambient air trapped in the internal cavity during a tire molding process. The at least two passages, however, are plugged to prevent the ambient air from being vented during the tire molding process.

### DRAWINGS

In the accompanying drawings, embodiments of a method of molding a tire are illustrated that, together with the detailed description provided below, describe example embodiments of the method. It will be appreciated that the illustrated boundaries of elements in the drawings represent one example of the boundaries. One of ordinary skill in the art will appreciate that one element may be designed as multiple elements or that multiple elements may be designed as a single element. An element shown as an internal component of another element may be implemented as an external component and vice-versa.

In the drawings and description that follows, like elements are identified with the same reference numerals.

The drawings are not to scale and the proportion of certain elements may be exaggerated for the purpose of illustration.

FIG. 1 is a schematic drawing of a partial section of one embodiment of a mold with a green tire placed therein.

FIGS. 2 through 4 are schematic drawings of the mold of FIG. 1 illustrating the green tire at different stages during collapsing of the mold.

FIG. 5 is a schematic drawing of a partial section of another embodiment of a mold.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms maybe within the definitions.

“Tread,” as used herein, refers to that portion of the tire that comes into contact with the road under normal load.

“Sidewall,” as used herein, refers to that portion of the tire between the tread and the bead.

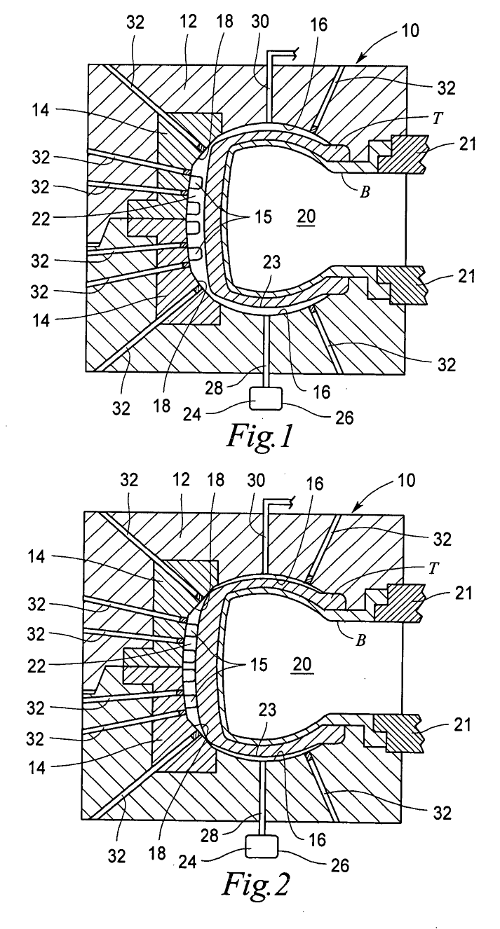

Referring now to FIGS. 1-4, one embodiment of a method of molding a tire according to the present invention is illustrated. In this method, a tire mold 10 is provided that comprises sideplates 12 and tread segments 14. Internal cavity-defining surfaces 16 and 18 of sideplates 12 and tread segments 14, respectively, define mold cavity 20. Tread segments 14 include one or more tread elements 15 that are used to form a tread pattern in a molded tire.

As shown in FIG. 1, green tire T is shown as it is initially placed into mold cavity 20, and a space 22 exists between the external surface of green tire T and internal cavity-defining surfaces 16 and 18 of mold 10. Tire mold 10 is configured to collapse around green tire T such that tread segments 14, tread elements 15, and internal mold surfaces 16, 18 mold shapes in the green tire T.

In the illustrated embodiment, a pressurized bladder B is provided to support the green tire T as the mold 10 is collapsed around the green tire T. In one embodiment, a pressurized high temperature fluid or gas is supplied to bladder B in order to pressurize bladder B and support green tire T as the mold 10 is collapsed around the green tire T. To hold bladder B in place during the molding process, clamps 21 are provided as shown in FIG. 1.

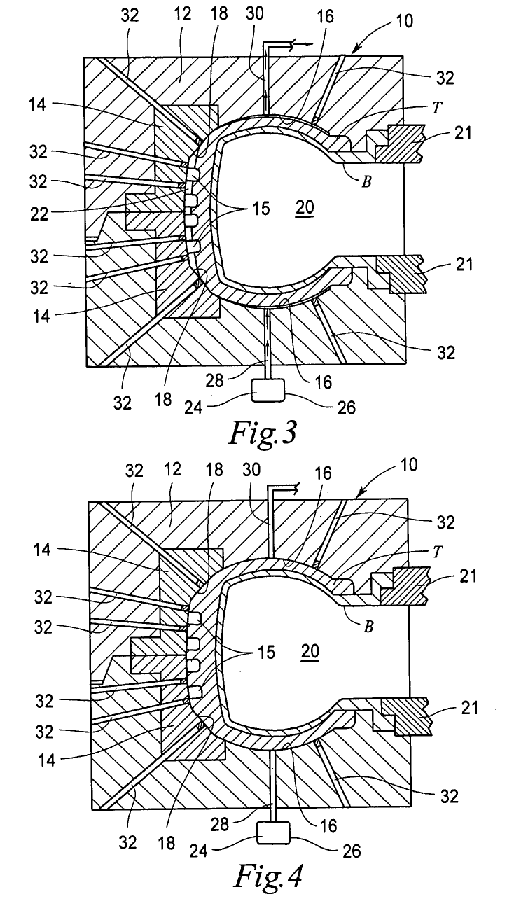

FIGS. 2-4 illustrate green tire T in tire mold 10 at different stages during collapsing of tire mold 10 around green tire T. After tread segments 14, tread elements 15, and internal mold surfaces 16, 18 make contact with the green tire T, mold 10 is heated for a predetermined time at a predetermined temperature or within a predetermined temperature range to cure green tire T, thereby yielding a cured tire. If bladder B is supplied with a pressurized high temperature fluid or gas to support green tire T, the additional heat from the fluid or gas may assist in curing green tire T.

Prior to the internal surfaces of mold 10 contacting the green tire T as shown in FIG. 1, an injection gas 24 is injected into the space 22 so as to both expel and replace the ambient air that occupies this space 22. In the illustrated embodiment, the injection gas 24 is stored in any suitable supply tank, holding tank, or canister 26 and introduced through at least one inlet port 28, and the purged air is released from the space 22 through at least one exit port 30. Although it is preferable the injection gas 24 is injected into the space 22 at a time just prior to the internal surfaces of mold 10 contacting the green tire T (since less injection gas 24 may be used to expel the ambient air), the injection gas 24 can be injected into the space 22 any time so long as it is before the internal surfaces of mold 10 contact the green tire T. Once the internal surfaces of mold 10 contact the green tire T as shown in FIG. 2, one or more pockets may be created between green tire T and tread elements 15, thereby preventing at least some of the ambient air from exiting the space 22.

It may be noted that inlet port(s) 28 and/or exit port(s) 30 can be the air vents used in a conventional “vented” mold. Also, the claimed method can be used with conventional tooling by plugging any additional air vents 32 that are not used to supply injection gas 24 or evacuate ambient air from the mold cavity 20. Accordingly, the claimed invention permits for the modification of conventional tooling, thereby reducing the economic expenditure necessary to implement the claimed method.

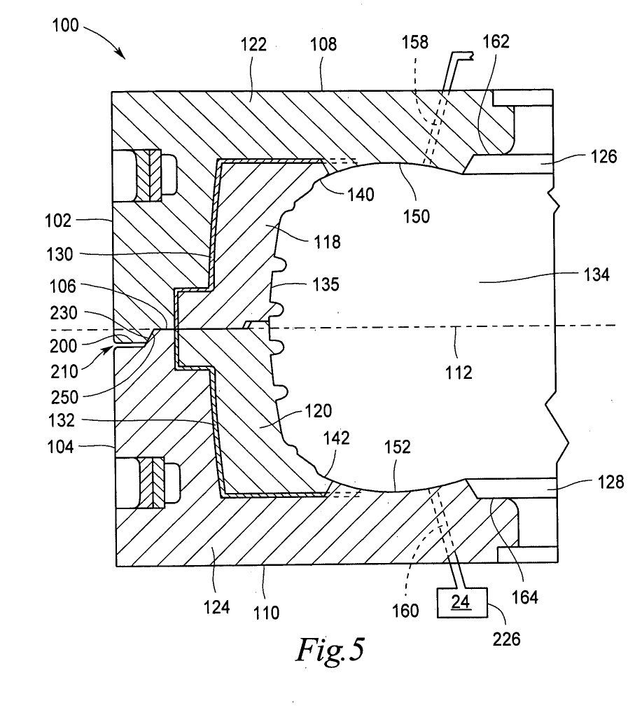

With regard to FIG. 5, a partial cross-sectional view of another embodiment of a tire mold 100 is illustrated. In this embodiment, tire mold 100 is configured for use in a platen press (not shown) for shaping and curing a pneumatic tire (not shown). Mold 100 includes an upper or male section 102 and lower or female section 104. Parting line 106 separates upper and lower sections 102, 104, with at least one of the sections 102, 104 being moveable in a direction perpendicular to parting line 106 away from the remaining section. By separating sections 102, 104, mold 100 is opened for introducing a green tire (not shown) into mold 100.

In mold 100 of FIG. 5, surface 108 of upper section 102 is substantially flat and parallel to surface 110 of lower section 104. Surfaces 108, 110 are substantially parallel to horizontal plane 112 containing parting line 106.

Each mold section 102, 104 includes tread segment components 118, 120; mold housing components 122, 124; bead ring components 126, 128; and insulator plates 130, 132. Tread segment components 118, 120 and insulator plates 130, 132 may be mounted to mold housing components 122, 124 by screws or other conventional means. However, other arrangements of insulator plates 130, 132 may be used, such as where insulator plates 130, 132 are positioned between a source of external heat and the tire (not shown).

Upper section 102 and lower section 104 of mold 100 fit together to form a toroidal mold cavity 134 with an inner shaping surface 135 of a predetermined configuration for shaping the tire.

As shown in FIG. 5, tread segment components 118, 120 have inclined inner surfaces 140 and 142, respectively, for shaping the shoulder portions of a tire. Surface 140 and curved inner surface 150 of upper section 102 shape one side of the tire, and surface 142 and curved inner surface 152 of lower section 104 shape the opposite side of the tire. Similar to the mold of FIGS. 1-4, mold 100 has at least one exit port 158 and one inlet port 160.

As in the embodiment of FIG. 1-4, an inject gas 24 is supplied to the interior of the mold via the at least one inlet port 160 from supply 226. The ambient air is purged via the at least one exit port 158, thus permitting removal of the ambient air that may become trapped between the tire and inner shaping surface 135 of the mold cavity 134. Although FIG. 5 is shown having one inlet, one supply and one exit port, the present invention is not limited thereto. For example, if multiple inlet ports 160 are present each could be mated to an individual supply 226, thereby permitting the introduction of a variety of injection gases or one injection gas at a variety of locations. Alternatively, the multiple inlet ports 160, if present could be mated to a single supply 226, thereby reducing the complexity of the device used to carry out the claimed invention and permitting the introduction of injection gas 24 at a variety of locations around the exterior of the tire (not shown), while the tire is in mold 100.

Mold 100 also has bead ring components 126, 128 for forming the bead portions of the tire (not shown). As shown, mold sections, 102, 104 are provided with recesses 162 and 164 to receive the conventional bead-forming rings 126 and 128. These may be held in place by screws (not shown) spaced around the perimeter or by other suitable means.

Mold housing component 122 of upper section 102 has a projecting key 200, and mold housing component 124 of lower section 104 has a recess 210 that is of a size to receive key 200. Mold housing component 124 has a tapered shoulder 230 that fits and engages a tapered inner surface 250 of key 200, thereby aligning mold sections 102, 104 when mold 100 is closed.

The material generally used to form the mold housing components 122, 124 and bead ring components 126, 128 may be any suitable compound which transmits the desired amount of heat/thermal energy to the interior of mold 100. For example, aluminum, steel or a combination of the two may be used to form mold 100.

In one embodiment, the injection gas 24 has density that is less than air. Alternatively, the injection gas 24 is chosen to have a gas permeability into the tire that is greater than air, thereby permitting the injection gas to be more easily absorbed by the rubber during the curing process. For example, the gas permeability of the injection gas may be at least twice than that of ambient air. However, in other embodiments, the gas permeability of the injection gas may be less than twice that of ambient air.

In one embodiment, the injection gas 24 may be non-combustible under the conditions associated with tire curing processes. For example, the injection gas 24 can include without limitation substantially pure helium, carbon dioxide, neon, argon, krypton, xenon, and combinations of these gases with at least one other gas (e.g., air or one another). In another embodiment, the injection gas is selected to be both non-reactive under the conditions at which the green tire is cured and to have an increased level of permeability over the normal atmosphere.

In one embodiment, the injection gas 24 may dissolve and/or be absorbed into the rubber compound or compounds of one or more of the exterior surfaces of the tire and then later evaporate after the curing process is completed. For example, the injection gas 24 may dissolve and/or be absorbed into the rubber compound used to form the tread of the tire. Alternatively, the injection gas 24 may dissolve and/or be absorbed into the rubber compound used to form the sidewalls of the tire.

In yet another embodiment, a tread portion of green tire T could have a scavenger component added that enables absorption of the gas into the rubber compound. Examples of scavenger components include without limitation silicon, silicate, and any other compounds that absorb moisture. Additionally, or alternatively, a coating that aids in absorption of the injection gas could be applied to the outside surface 23 of green tire T and/or the inner surface of mold 10.

The claimed invention is also applicable to the various types of molds used in the tire production, including a sectional mold wherein a multisection mold is circumferentially enclosed with a band.

The use of an injection gas 24 enables the process of the present invention to yield tires having fewer, if any, surface recesses (lightness in the tire) and vents. In addition, the use of injection gas 24 reduces or eliminates spewing, as well as the need for the multitude of air vents in the mold that cause spewing and the additional trimming step. The claimed method also eliminates the need to address the problem of trapped air by evacuating the mold cavity prior to placement of the green tire into the mold cavity via vacuum equipment.

As would be apparent to one of skill in the art, the claimed invention is not limited in applicability to the molds of FIGS. 1-5; rather, the claimed invention can be used in conjunction with any tire mold, regardless of whether such mold has one or more vent holes. In the case where a tire mold has no vent holes, inlet and exit ports in accordance with the present invention can be fabricated by processes known in the art (e.g., drilling, boring, etc.).

The methods for a molding tire described above can be used to eliminate or significantly reduce the number of vent holes and/or slits in a conventional tire mold needed to vent air trapped in the internal mold cavity during the tire curing process. If the vent holes and/or slits are eliminated, then secondary processes needed to trim excess rubber projections present on the exterior of the cured tire (formed from rubber penetrating the vent holes or slits) can also be eliminated. The methods described above also eliminate the need for vacuum-assisted removal of trapped air from tire molds.

While the present application illustrates various embodiments, and while these embodiments have been described in some detail, it is not the intention of the applicant to restrict or in any way limit the scope of the claimed invention to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's claimed invention.

1. A method of molding a tire comprising the steps of:
placing a green tire in a mold, the mold having internal cavity-defining surfaces;
injecting an injection gas into a space defined between an external surface of the green tire and the internal cavity-defining surfaces of the mold; and
curing the green tire within the mold.

2. The method of claim 1, wherein the injection gas has a permeability that is at least twice than that of ambient air.

3. The method of claim 1, wherein the injection gas comprises helium.

4. The method of claim 1, wherein the injection gas is selected from a group consisting of helium, carbon dioxide, neon, argon, krypton, xenon, combinations thereof, and combinations with air.

5. The method of claim 1, wherein a tread portion of the green tire is constructed of at least one rubber compound that includes at least one added scavenger component that enables absorption of the injection gas into the rubber compound.

6. The method of claim 1, further comprising the step of applying a coating that aids in absorption of the injection gas to an outside surface of the green tire.

7. The method of claim 1, further comprising the step of applying a coating that aids in absorption of the injection gas to one or more of the internal cavity-defining surfaces of the mold.

8. The method of claim 1, further comprising the step of forming the mold by retrofitting an existing mold having two or more air vent passages.

9. The method of claim 7, further comprising the step of plugging at least one of the air vent passages.

10. A method of molding a tire comprising the steps of:
placing a green tire in a mold, the mold having internal cavity-defining surfaces and the green tire having an internal portion and an external portion;
injecting an injection gas into a space defined between an external surface of the green tire and the internal cavity-defining surfaces of the mold;
collapsing the mold around the green tire until the internal cavity-defining surfaces of the mold are pressed against the green tire; and
curing the green tire within the mold.

11. The method of claim 10, further comprising the steps of:
placing a bladder in the internal portion of the green tire; and
inflating the bladder to support the green tire as the mold is collapsed around the green tire.

12. The method of claim 10, wherein the injection gas has a permeability that is at least twice than that of ambient air.

13. The method of claim 10, wherein the injection gas comprises helium.

14. The method of claim 10, wherein a tread portion of the green tire is constructed of at least one rubber compound that includes at least one added scavenger component that enables absorption of the injection gas into the rubber compound.

15. The method of claim 10, further comprising the step of applying a coating that aids in absorption of the injection gas to an outside surface of the green tire.

16. The method of claim 10, further comprising the step of applying a coating that aids in absorption of the injection gas to one or more of the internal cavity-defining surfaces of the mold.

17. A system for molding a tire, the system comprising:
a mold assembly having an internal cavity and an external surface, wherein the mold assembly is capable of being opened and is formed from an upper portion and a lower portion, the upper and lower portions combining to form the internal cavity, the mold assembly further comprising:
at least one tread imparting structure;
at least one inlet port located in the mold assembly, wherein the at least one inlet port is adapted to supply an injection gas to the internal cavity of the mold assembly;
at least one exit port located in the mold assembly, wherein the at least one exit port is adapted to vent any ambient air trapped in the internal cavity during a tire molding process; and
means for supplying the injection gas to the mold assembly via the at least one inlet port.

18. The system of claim 17, wherein the internal cavity is a tire-shaped cavity.

19. The system of claim 17, further comprising means for supporting the tire during the tire molding process.

20. The system of claim 17, wherein the supporting means comprises a pressurized bladder located within the tire.

21. A tire mold comprising:
a mold housing having an internal surface that defines an internal cavity and an external surface, the mold housing includes at least two passages that extend from the internal surface to the external surface and configured to vent ambient air trapped in the internal cavity during a tire molding process;
wherein the at least two passages are plugged to prevent the ambient air from being vented during the tire molding process.

22. The tire mold of claim 21, wherein the mold housing includes at least one inlet port configured to supply an injection gas to the internal cavity of the mold housing.

23. The tire mold of claim 22, wherein the mold housing includes at least one exit port configured to vent any ambient air trapped in the internal cavity during the tire molding process.
